(19) United States
(12) Patent Application Publication
(10) Pub. No.: US 2026/0251307 A1
(43) Pub. Date: Aug. 27, 2026

(54) DYNAMIC HEAT INSULATION TOWARDS PRESSURE GAIN COMBUSTION

(71) Applicant: UNM RAINFOREST INNOVATIONS, Albuquerque, NM (US)

(72) Inventor: Georgios KOUTSAKIS, Albuquerque, NM (US)

(73) Assignee: UNM RAINFOREST INNOVATIONS, Albuquerque, NM (US)

(21) Appl. No.: 19/548,222

(22) Filed: Feb. 24, 2026

Related U.S. Application Data
(60) Provisional application No. 63/763,575, filed on Feb. 26, 2025.

(51) Int. Cl. F23R 7/00; F02C 7/24

(52) U.S. Cl. CPC F23R 7/00; F02C 7/24

(57) ABSTRACT

A pressure gain combustion device is disclosed that includes at least one component configured to be subjected to combustion gases, the component including: a coating applied to the at least one component, the coating comprises an insulating layer, wherein the insulating layer follows a transient gas temperature profile during operation of the pressure gain combustion device.

### CROSS REFERENCE TO RELATED APPLICATIONS

This application claims benefit to U.S. Provisional Application No. 63/763,575 filed on Feb. 26, 2025, the contents of which are hereby incorporated by reference in its entirety.

### TECHNICAL FIELD

The present teachings relate generally to combustion chamber surfaces, and more particularly, to dynamic heat insulation for pressure gain combustion engines, including rotating detonation engines.

### BACKGROUND

The Rotating Detonation Engine (RDE) has shown the potential to become a new class of propulsion and power-generation engine. The real advantage may not solely stem from the theoretical thermal efficiency and specific impulse increase—about 10-15% compared to constant-pressure combustors—but rather from the system's compactness and scalability. However, there are several challenges to overcome before the combustor gets safely integrated into gas turbines or rocket engines. One of these challenges is the extreme heat flux that is released during detonation. Due to the magnitude of the observed heat fluxes, the experiments have been limited for short-duration using heat-sink chambers, or longer-duration with extensively cooled components.

To deal with such an environment, RDE materials range from copper, steel, fused quartz, Ceramic Matrix Composites (CMC), or a combination of carbon-carbon composite and copper. These materials have proven successful in long-term operation only when significant cooling is provided to the engine. However, by keeping the combustor wall in a relatively low temperature, the heat losses are increased thus the engine efficiency is compromised. In addition, large temperature gradients promote thermal stresses and oxidation rates in the material, undermining the structural integrity of the combustor.

As a consequence, new thermal management techniques should be explored. Thermal engines often use protective coatings along with active cooling and film cooling for the components exposed to extreme thermal conditions. Focusing on coatings, the most well-known examples are the Thermal Barrier Coatings (TBC) for jet engines and gas turbines. These enable the heat transfer reduction primarily by minimizing the coating's thermal conductivity because the cycle is time-independent. TBCs have also been explored in dynamic heat flux environments i.e. reciprocating piston internal combustion engines (ICE). The deflagrative heat release of the gas results to a wall surface heat flux that has a Gaussian-like profile. The closed-cycle ICE produces peak heat flux and cycle times of at least one and two-to-three orders of magnitude difference in cycle time, respectively, as compared to an RDE. Recent attempts to mitigate reductions in heat flux combined with volumetric efficiency or engine breathing penalty using a thin, low heat conductivity, k and low-volumetric heat capacity, ρc, material that can follow the gas temperature. Although the heat flux profiles may be similar, the design objectives for each application are anticipated to be significantly different.

### SUMMARY

According to examples of the present disclosure, a class of materials is disclosed to dynamically reduce instantaneous heat fluxes in pressure gain combustion engines, such as Rotating Detonation Engine (RDE) combustor chamber walls. The high-frequency and high-amplitude surface heat fluxes observed in RDEs arise from large instantaneous temperature differences between the detonation shockwave and chamber wall surface. These temperature gradients drive substantial energy loss and reduce the chamber gas pressure, ultimately limiting the cycle's thermodynamic efficiency. This work introduces a concept for dynamically insulating the combustion chamber surfaces using surface layers or coatings with low thermal time scale. With such coatings, the surface temperature may follow the fluctuations of the cyclic detonation wave temperature, thus reducing the instantaneous heat flux and therefore cycle-mean heat flux. To analyze these cyclic thermal phenomena, a one-dimensional analytical conduction solver was used with the capability to handle multilayered structures. Parametric modeling was performed using transient heat flux boundary conditions representative of a hydrogen-air RDE across a broad range of coating thermal properties and engine conditions. The coating effectiveness scaled with the product of thermal time constant and detonation wave frequency and the results were non-dimensionalized to guide future materials development. This strategy may offer benefits in increasing material survivability, reducing cooling requirements, and enhancing pressure gain.

According to examples of the present disclosure, a dynamic heat insulation is provided in engine designs such as, but not limited to, combustors. An analytical solution of the wall surface temperature of the combustor is introduced based on experimental heat flux and backside cooling boundary conditions, to be used as a tool to evaluate coating thermal performance. Different material thermophysical properties and detonation regimes are explored, in an effort to map the coating's behavior. In addition, real and conceptual coating-substrate configurations are simulated to show the effect of thermal properties on the wall response. Finally, non-dimensional numbers are discussed as a more generic way to represent the influence of each parameter on the engine performance.

According to examples of the present disclosure, a pressure gain combustion device is disclosed and comprises at least one component configured to be subjected to combustion gases, the component comprising an insulating layer, wherein the insulating layer follows a transient gas temperature profile during operation of the pressure gain combustion device. According to examples of the present disclosure, a pressure gain combustion device is disclosed that comprises at least one component configured to be subjected to combustion gases, the component comprising: a substrate comprising a surface; and a coating applied to the surface, the coating comprises an insulating layer, wherein the insulating layer follows a transient gas temperature profile during operation of the pressure gain combustion device.

Various additional features can be included in either of the pressure gain combustion device including one or more of the following features. The pressure gain combustion device further comprises a rotation detonation engine, a pulse detonation engine, a wave rotor combustor, or pulsejet engine, and wherein the insulating layer comprises a refractory alloy or a ceramic matrix composite. The insulating layer is a swing or dynamic coating where a thermal conductivity and a heat capacity of the insulating layer rapidly changes the surface temperature at the insulating layer while minimizing instantaneous temperature differences with combustion gases. The insulating layer has thermal conductivity and a heat capacity of the insulating layer rapidly changes the surface temperature at the insulating layer while minimizing instantaneous temperature differences with combustion gases. The insulating layer is a swing or dynamic coating that minimizes instantaneous heat flux, thereby reducing a time-averaged heat flux during operation of the pressure gain combustion device. The insulating layer minimizes instantaneous heat flux, thereby reducing a time-averaged heat flux during operation of the pressure gain combustion device. The insulating layer is a swing or dynamic coating or the insulating layer itself has a thermal conductivity between 0.02 W/m K and 2.5 W/m K, a volumetric heat capacity between 200 ρCp (kJ/m³·K) and 2800 ρCp (kJ/m³·K), a melting point between 1500° C. and 3000° C., a material thickness between 1 μm and 1000 μm. The swing or dynamic coating or the insulating layer itself has an apparent density between 0.1 g/cm³ and 1.0 g/cm³, a porosity percentage between 10% and 95%, a sealing layer thickness between 1 μm and 20-50 μm, a feature size between 0.02 μm and 800 μm, a pore diameter between 1 nm and 500 nm, a specific surface area between 100 and 1000, a temperature capability between 1300° C. and 2700° C., and a mechanical strength between 70 MPa and 3300 MPa. The feature size comprises a diameter of a particle or a microsphere.

According to examples of the present disclosure, a method of forming a coating for use on a component of a pressure gain device is disclosed that comprises providing a surface that is subjected to combustion gases, the surface comprises an insulating layer, wherein the insulating layer follows a transient gas temperature profile during operation of the pressure gain combustion device. Various additional features can be included in the method including one or more of the following features. The pressure combustion device comprises a rotation detonation engine, a pulse detonation engine, a wave rotor combustor, or pulsejet engine. The insulating layer is a swing or dynamic coating or the insulating layer itself has a thermal conductivity and a heat capacity of the insulating layer rapidly changes a surface temperature at the insulating layer while minimizing instantaneous temperature differences with combustion gases. The insulating layer is a swing or dynamic coating or the insulating layer itself minimizes instantaneous heat flux, thereby reducing a time-averaged heat flux during operation of the pressure gain combustion device. The insulating layer is a swing or dynamic coating or the insulating layer itself has a thermal conductivity between 0.02 W/m K and 2.5 W/m K, a volumetric heat capacity between 200 ρCp (kJ/m³·K) and 2800 ρCp (kJ/m³·K), a melting point between 1500° C. and 3000° C., and a material thickness between 1 μm and 1000 μm. The swing or dynamic coating or the insulating layer itself has an apparent density between 0.1 g/cm³ and 1.0 g/cm³, a porosity percentage between 10% and 95%, a sealing layer thickness between 1 μm and 20-50 μm, a feature size between 0.02 μm and 800 μm, a pore diameter between 1 nm and 500 nm, a specific surface area between 100 and 1000, a temperature capability between 1300° C. and 2700° C., and a mechanical strength between 70 MPa and 3300 MPa. The feature size comprises a diameter of a particle or a microsphere.

According to examples of the present disclosure, a detonation engine is disclosed that comprises at least one component configured to be subjected to combustion gases, the component comprising: a substrate comprising a surface; and a coating applied to the surface, the coating comprises an insulating layer, wherein the insulating layer follows a transient gas temperature profile during operation of the pressure gain combustion device. Various additional features can be included in the detonation engine including one or more of the following features. The insulating layer is a swing or dynamic coating or the insulating layer has a thermal conductivity and a heat capacity of the insulating layer rapidly changes the surface temperature at the insulating layer while minimizing instantaneous temperature differences with combustion gases. The insulating layer is a swing or dynamic coating or the insulating layer itself minimizes instantaneous heat flux, thereby reducing a time-averaged heat flux during operation of the pressure gain combustion device. The insulating layer is a swing or dynamic coating or the insulating layer itself has a thermal conductivity between 0.02 W/m K and 2.5 W/m K, a volumetric heat capacity between 200 ρCp (kJ/m³·K) and 2800 ρCp (kJ/m³·K), a melting point between 1500° C. and 3000° C., and a material thickness between 1 μm and 1000 μm. The swing or dynamic coating or the insulating layer has an apparent density between 0.1 g/cm³ and 1.0 g/cm³, a porosity percentage between 10% and 95%, a sealing layer thickness between 1 μm and 20-50 μm, a feature size between 0.02 μm and 800 μm, a pore diameter between 1 nm and 500 nm, a specific surface area between 100 and 1000, a temperature capability between 1300° C. and 2700° C., and a mechanical strength between 70 MPa and 3300 MPa. The insulating layer comprises a refractory alloy or a ceramic matrix composite.

### BRIEF DESCRIPTION OF THE FIGURES

The above and/or other aspects and advantages will become more apparent and more readily appreciated from the following detailed description of examples, taken in conjunction with the accompanying drawings, in which:

FIG. 1 shows a plot of temperature versus detonation wave angle showing the variation of the gas temperature, and the gas-wall interfaces of substrate only, traditional insulation, and dynamic heat insulation configurations within a sustained rotating detonation wave cycle according to examples of the present disclosure.

FIG. 2A shows a plot of gas temperature and spatial temperature distributions versus time, FIG. 2B shows a plot of gas temperature and spatial temperature distributions versus time for the substrate only, FIG. 2C shows a plot of gas temperature and spatial temperature distributions versus time for the traditional insulation, FIG. 2D shows a plot of gas temperature and spatial temperature distributions versus time for the dynamic heat insulation configurations according to examples of the present disclosure. The points illustrate three different times during the RDE cycle: during the refill stage (1), detonation (2) and products expansion (3).

FIG. 3 shows a plot of thermal conductivity (k) versus volumetric heat capacity (ρc) of different TBC topcoat and substrate materials according to examples of the present disclosure.

FIG. 4A shows a plot of temperature versus time showing time-resolved surface temperature swing for coating thermal conductivity, k, FIG. 4B shows a plot of temperature versus time showing time-resolved surface temperature swing for coating volumetric heat capacity, ρc, FIG. 4C shows a plot of temperature versus time showing time-resolved surface temperature swing for coating thickness, L, and FIG. 4D shows a plot of temperature versus time showing time-resolved surface temperature swing for a number of detonation waves according to examples of the present disclosure.

FIG. 5A shows a plot of temperature versus time showing coating-substrate combinations comparison and FIG. 5B shows a plot of temperature versus time showing non-dimensional representation Θ-Ω according to examples of the present disclosure.

FIG. 6 shows a plot of data for the time variation in gas temperature taken from Rein et al. (2017). Superimposed are the nominal wall temperatures in a rotating detonation engine together with the expected surface temperature variation with a swing or dynamic coating.

FIG. 7 shows a schematic illustration of the inner and outer wall temperature distribution during the fresh mixture cooling phase and the detonation wave front phase according to examples of the present disclosure.

### DETAILED DESCRIPTION

Exemplary aspects will now be described more fully with reference to the accompanying drawings. Examples of the disclosure, however, can be embodied in many different forms and should not be construed as being limited to the examples set forth herein. Rather, these examples are provided so that this disclosure will be thorough and complete, and will fully convey the scope to those skilled in the art. In the drawings, some details may be simplified and/or may be drawn to facilitate understanding rather than to maintain strict structural accuracy, detail, and/or scale.

It will be understood that when an element is referred to as being “on,” “associated with,” “connected to,” or “coupled to” to another component, it may be directly on, associated with, connected to, or coupled to the other component or intervening components may be present. In contrast, when a component is referred to as being “directly on,” “directly associated with,” “directly connected to,” or “directly coupled to” another component, there are no intervening components present. As used herein, the term “and/or” includes any and all combinations of one or more of the associated listed items.

It will be understood that although the terms first, second, etc., may be used herein to describe various elements, components, and/or directions, these elements, components, and/or directions should not be limited by these terms. These terms are only used to distinguish one element, component, and/or direction from another element, component, and/or direction. For example, a first element, component, or direction could be termed a second element, component, or direction without departing from the teachings of examples.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation(s) depicted in the figures.

### NOMENCLATURE

C=capacitance per unit area [J m⁻² K⁻¹]
c=specific heat capacity [J kg⁻¹ K⁻¹]
h=heat transfer coefficient [W m⁻² K⁻¹]
k=thermal conductivity [W m⁻¹ K⁻¹]
L=layer thickness [m]
\dot{q}″=heat flux [W m⁻²]
\dot{q}=rate of heat transfer [W]
R=thermal resistance [m² K W⁻¹]
T=temperature [K]
X=combustion chamber response function [K m² W⁻¹]
Y=coolant surface response function [-]
α=thermal diffusivity [m² s⁻¹]
δ=Dirac's delta function [-]
Θ=dimensionless temperature [-]
ρ=density [kg m⁻³]
Φ=equivalence ratio [-]
Ω=dimensionless time scale [-]

According to examples of the present disclosure, a method/system/device is disclosed that modify the combustion chamber surface materials properties to provide dynamic heat insulation and thus increase performance of pressure gain combustion devices This can be applying to rotating detonation engines (RDE), pulse detonation engines (PDE), wave rotor combustor and pulsejet engine).

In simple terms, by providing potential heat insulation, not as much heat is not going to rejected/wasted for cooling and/or to the ambient through conduction within the walls, rather it will be used to increase performance of said devices. One example of the present disclosure relates to a surface layer or coating with optimized properties as compared to the substrate structure. Another example of the present disclosure relates to how or which manufacturing process that this concept/coating can be used with.

The disclosure describes a dynamic heat insulation concept that is for a pressure gain combustion devices and particularly the rotating detonation engine. Potential application of the RDE in the future is to be used as a replacement of conventional combustor of gas turbine engine that can be used either for propulsion or power generation. Other applications may be rockets, missiles and hypersonic vehicles. The disclose also describes the material properties to be optimized (thermal conductivity, specific heat capacity, density and coating thickness) are expected to be significantly different. One reason is that the RDE has two to three orders of magnitude faster thermodynamic cycle than the ICE. In terms of heat flux, the RDE may provide more than one order of magnitude higher peak and time-average thermal load than its ICE counterpart. Thus, the optimum material properties will be significantly different and will have to withstand much higher temperature. Early evidence shows the thermal conductivity will need to increase in RDE vs a decrease that is desired for ICEs.

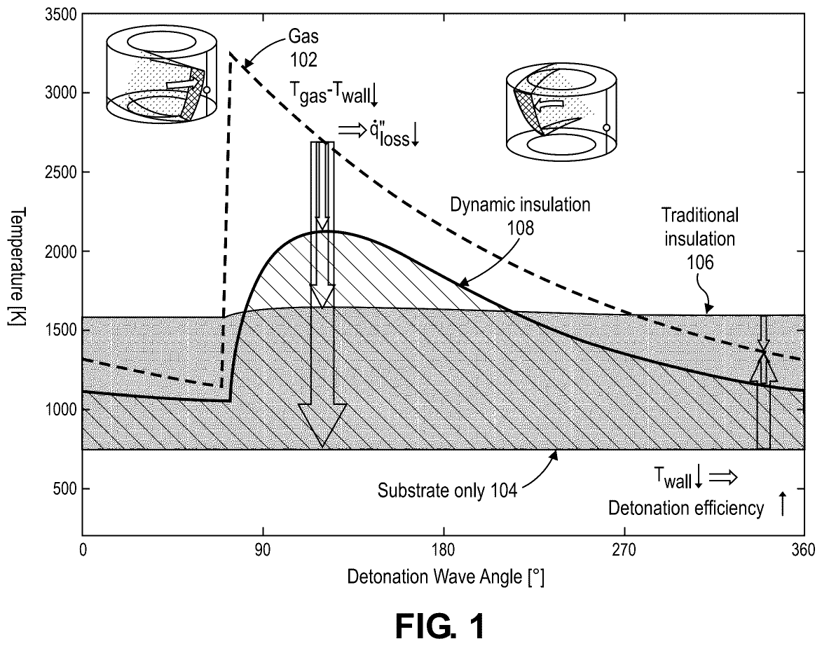

FIG. 1 shows variation of the gas temperature (dashed line 102), and the gas-wall interfaces of substrate only (line 104), traditional insulation (line 106) and dynamic heat insulation (line 108) configurations within a sustained rotating detonation wave cycle.

FIG. 1 illustrates the gas temperature, T_{gas}, (dashed line 102) during a period of the RDE cycle, as a function of time or detonation wave angle relative to a fixed point in the annulus shown in the schematics. When the detonation wave passes through the point, the temperature instantly rises. Then, the temperature falls gradually as products expand and fresh mixture is inserted in the engine. This process is repeated at kHz frequency rates. The surface temperature profiles shown below refer to the sustained cycle, when the structure has achieved thermal equilibrium. For this RDE-like T_{gas}, the response of the wall surface temperature, T_{wall}, for three material architectures is presented: substrate only, traditional insulation, and dynamic heat insulation.

A substrate only architecture is the baseline type of combustion chamber wall that comprises moderate to high thermal conductivity and high volumetric heat capacity materials. Due to the high volumetric heat capacity of these materials, T_{wall} remains constant throughout the cycle. This configuration is encountered in most RDEs in literature and extensive cooling is used to keep T_{wall} under operational temperature limits. As a result, heat losses are increased, introducing a large wall thermal gradient that creates significant thermal stress on the combustor. In addition, metallic surfaces at high temperature are prone to oxidation, meaning that the metallic substrate only case will most likely fail due to the severely oxidizing environment of the RDE, even if the extreme thermal stresses are managed.

A traditional TBC coating, i.e. YSZ, on a substrate configuration could be introduced as a solution to the above problems; this is referred to as traditional insulation. The configuration has been successfully implemented in constant-pressure combustors for decades. Its applicability in RDEs has not been studied yet in the literature, but the low-k coating is expected to reduce the cycle-mean heat flux by introducing significant thermal resistance to the problem, as shown in FIG. 1. In addition, TBCs are ceramic materials that prevent oxygen diffusion to the metallic surfaces, thus introducing the aforementioned oxidation quite effectively. However, traditional TBCs have high volumetric heat capacity, ρc. As a consequence, T_{wall} remains relatively constant during the cycle and higher than substrate only configurations. This enables higher temperature inside the combustor during the entire cycle, increasing the probability for reactants' auto-ignition. Since the reactants flow continuously inside the combustor, the higher combustor temperature may promote deflagrative burning of the fresh mixture, as has already been reported for substrate only configurations. Pronounced parasitic deflagrations can compromise the efficiency and stability of RDEs.

To further improve thermal management during detonation and amend the poor performance of the traditional insulation in the reactants refill region, the dynamic heat insulation is disclosed. This concept suggests the use of a low-k, low-ρc coating that can follow the gas temperature and thus minimize the instantaneous temperature difference, T_{gas}−T_{wall}, which drives convective heat transfer as

$${\dot{q}}_{loss}^{″} = h ( {T}_{gas} - {T}_{wall} ) .$$

It is useful to highlight that this work assumes the convection heat transfer coefficient, h, remains constant between these three wall cases, and the main heat transfer mechanism is convection. The line 108 in FIG. 1 depicts the T_{wall} of the dynamic heat insulation following T_{gas}. The arrows depict the performance gain for each architecture. During the detonation phase, the dynamic heat insulation presents the lowest T_{gas}−T_{wall}, thus

$${\dot{q}}_{loss}^{″}$$

During the reactants refill phase, the dynamic heat insulation allows for rapid cooling of the wall, thus achieving lower surface temperatures relative to the Traditional Insulation. This behavior is anticipated to lower the likelihood of parasitic combustion and unintended auto-ignition. Therefore the detonation efficiency may be improved as a consequence of the reduction in the percentage of the fuel-oxidizer mixture that auto-ignites before the detonation wave arrival.

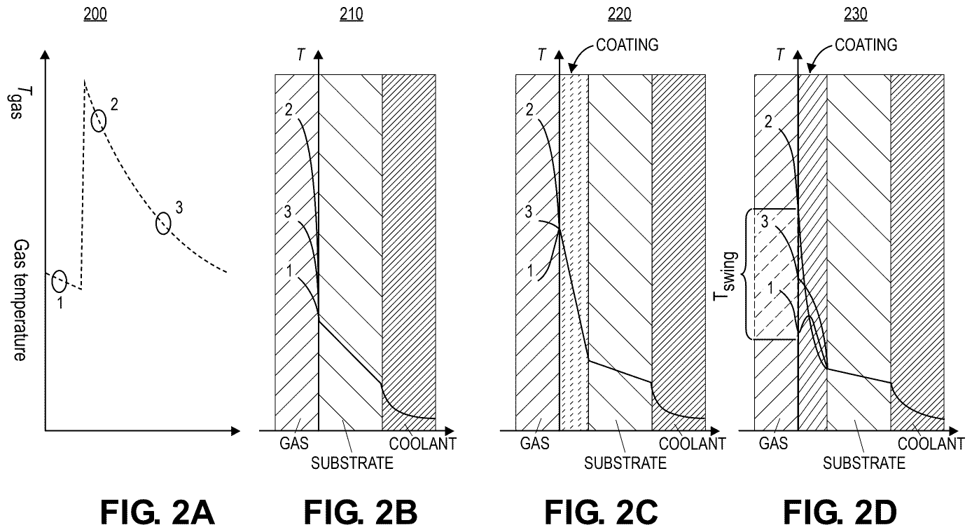

FIG. 2A, 2B, 2C, 2D shows the temperature distributions 200, 210, 220, and 130, respectively, for the three wall configurations at three different times during the refill stage (1), detonation (2) and products expansion (3). It is observed that the substrate only configuration has the greatest heat losses, as shown in FIG. 2B. The high ρc and thickness of the substrate result to high thermal inertia, meaning that the wall cannot follow the gas. The wall temperature gradient in the substrate is the steepest compared to the other two cases and the boundary conditions remain fixed.

The traditional insulation architecture comprises the TBC and the substrate as shown in FIG. 2C. Both layers have constant boundary temperatures and gradients, since their thermal inertia remains high. The difference with the substrate only case is that the coating can achieve higher T_{wall} due to its low k and can withstand greater temperature gradient throughout its thickness, reducing the thermal stresses in the substrate. The heat losses may be reduced, however, there are time intervals in which the heat flux reverses and is absorbed by the fresh reactants. This phenomenon may promote parasitic deflagrations, which harm the RDE efficiency and stability as discussed above.

The dynamic heat insulation case comprises the low ρc coating and the substrate, see FIG. 2D. Due to the low thermal inertia of the coating, the wall surface temperature can follow the high frequency cycle of the RDE. It is noted that the gradient inside the coating is no longer constant. It adapts between the varying gas temperature and the constant temperature at the insulation-substrate interface. Compared to the traditional insulation, the dynamic heat insulation T_{wall} is always closer to T_{gas}, minimizing heat losses and potential parasitic combustion.

The analytical solution of the 1D unsteady heat transfer equation in cartesian coordinates is considered, Eq. 1:

$$k \frac{{\partial }^{2} T}{\partial {x}^{2}} = ρ c \frac{\partial T}{\partial t} \qquad ( 1 )$$

Cartesian coordinates significantly simplify the analytical solution of the problem. The combustor annulus curvature and the thickness of the wall are not large enough to distort the solution. The one-dimensional assumption stems from the fact that the Peclet number, Pe, is very small. The Pe number is defined as Pe=Vl/α where V is the detonation wave speed (~1500 m/s), l is the perimeter of the engine (l≈0.5 m) and ais the thermal diffusivity of the wall (α≈1-100×10⁻⁶ m²/s). For RDE problems, Pe number is in the order of 105-107, meaning that the wall heat diffusion becomes negligible in comparison to the advective heat transfer of the detonation wave. However, it is worth noting that dynamic heat insulation coatings have low ρc, thus α, rendering this assumption weaker while moving to more suitable dynamic coatings. From the analytical solution that follows, the thermophysical properties of all materials are assumed constant, i.e., independent of temperature changes. The values of ρ, c and k are taken for temperatures close to 1000 K. For higher temperatures, changes mainly in k are very small due to phonon scattering. Lower material temperatures are less likely due to the extreme RDE thermal environment.

The mathematical solution of the heat diffusion equation, Eq. 1, is derived using the matrix method and complex analysis/residue-calculus Laplace transform inversion techniques. The unsteady conduction within the solid, either single- or multi-layered wall, can be modeled using an analytical technique that calculates the wall temperature only at the combustion surface “node” as opposed to finite difference schemes that must compute the temperature at every single node. This solution is exact (except for temporal discretization), whereas finite difference methods require high node density (and computational time) to achieve accuracy. The mathematical solution relies on complex analysis to invert the Laplace transform of surface temperature from the frequency domain back to the time domain. This leads to two time response functions, which “connect” the temperature to heat flux. The time response functions, X₀ and Y₀, which describe the multi-layer conduction physics, only need to be calculated once before the simulation initiates. The X₀ response refers to the surface temperature rise due to an input heat flux, \dot{q}″ at the combustion surface while the Y₀ response refers to the surface temperature rise due to a temperature change of the back-side coolant surface, T_{N}. The surface temperature, T_{wall}, can be shown to be the convolution of the previous heat flux or coolant temperature with the respective response function. The superposition of the two subproblems provides the instantaneous wall surface temperature, T_{wall}, for a multilayer as:

$${T}_{wall} ( t ) = {X}_{0} \text{?} {\dot{q}}^{″} + {Y}_{0} \text{?} {T}_{N} \qquad ( 2 )$$

To the authors' knowledge, there are only a few time-resolved heat flux measurements in open literature. Typically, these sensors are operated for a couple of seconds of an RDE test run before they failed. The latest measurements use traverse-thermoelectric, thin-film and atomic-layer thermopile (ALTP)-based heat flux sensor. The heat flux data from Athmanathan, V., Wang, R. B., Webb, A. M., Huber, K., Rodiger, T., Braun, J., Roy, S., Fugger, C. A., and Meyer, T. R., “MHz Rate In-Situ Direct Surface Heat-Flux Measurements in a Rotating-Detonation Engine,” AIAA SCITECH 2025 Forum, 2025, p. 2146, which is hereby incorporated by reference in its entirety, are used in this disclosure. Several curve fitting procedures in these data reveal that the heat flux can be reproduced by a convolution of the Dirac delta function δ(t), a scaling term A, an exponential decay term e^{-Bt}, and an offset term

$${\dot{q}}_{offset}^{″} :$$

$${\dot{q}}^{″} ( t ) = A δ ( t ) \text{?} {e}^{- Bt} + {\dot{q}}_{offset}^{″} \qquad ( 3 )$$

The Dirac's delta function, δ(t), represents the heat flux jump due to the detonation wave arrival, A gives the magnitude of the heat flux, the exponential decay, e^{-Bt}, gives the trough during the product expansion and reactants refill phase and

$${\dot{q}}_{offset}^{″}$$

is the background heat flux component.

The backside temperature boundary condition, T_{N}, can be calculated through a simple heat transfer problem using Eq. (4). The cycle mean heat flux,

$${\dot{q}}_{mean}^{″} ,$$

is dissipated from a working fluid at temperature T_{f}, flowing in a cooling channel of heat convection coefficient, h.

Water is chosen as the working fluid, at T_{f}=350 K, according to Hernandez-McCloskey, J., Teasley, T. W., Petty, D. M., Reutlinger, S. A., and Pineda, D. I., “Calorimeter Heat Flux Trends in NASA's Subscale Rotating Detonation Rocket Engine,” AIAA SCITECH 2025 Forum, 2025, p. 1979 and the mean h value is calculated according to the literature in Vrocharis, D., and Koutsakis, G., “Flow and Heat Transfer Characteristics of Additively Manufactured Mini Channels,” Turbo Expo, Vol. 88827, American Society of Mechanical Engineers, 2025, p. V006T13A012 and Ruan, A., Grasa, S., Gejji, R., Grunenwald, J., Slabaugh, C., and Paniagua, G., “Thermo-Structural Design of an Air-Cooled Rotating Detonation Combustor for Gas Turbine Integration,” Turbo Expo, Vol. 88810, American Society of Mechanical Engineers, 2025, p. V005T11A001. The backside temperature can be found as:

$${T}_{N} = {T}_{f} + \frac{{\dot{q}}_{mean}^{″}}{h}$$

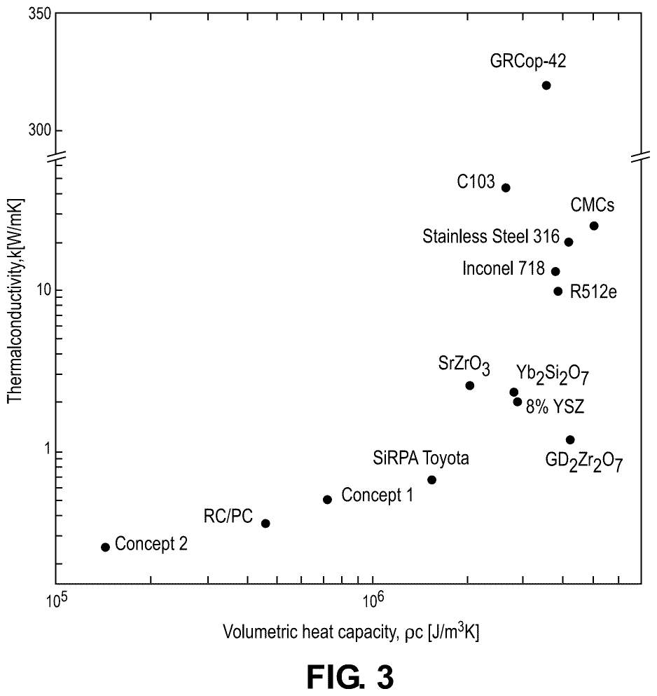

To bound Eq. 2, the terms X₀ and Y₀ need to be defined. These terms are the responses of the system and are defined by the boundary conditions and the thermophysical properties of the system. Their mathematical solutions can be found elsewhere, such as in Koutsakis, G., and Ghandhi, J., “Analytical solution of unsteady heat conduction in multilayer internal combustion engine walls,” Applied Thermal Engineering, Vol. 213, 2022, p. 118681. FIG. 3 shows a plot 300 of thermal conductivity (k) versus volumetric heat capacity (ρc) of different TBC topcoat and substrate materials according to examples of the present disclosure. FIG. 3 lists substrates and coatings that have been used in RDEs or gas turbine and rocket engine related applications, in a diagram of thermal conductivity, k, against volumetric heat capacity, ρc. In RDEs, substrate only configurations widely used in the open literature are Stainless Steel 316 (SS316) and GRCop-42. Other substrate materials commonly encountered in conventional gas turbines and rocket engines are Inconel 617 or 718, Hastelloy X and C103. In addition, Ceramic Matrix Composites (CMC) have been explored recently, as they combine the high temperature oxidation rate resistance of ceramics with the fracture toughness and thermal shock resistance of fibers. In gas turbine and rocket engine applications, coatings are used to protect the parts of the engine that are exposed to the highest heat fluxes. The most common coating that has been used steadily for over three decades is the Yttrium-Stabilized Zirconia (YSZ), a ceramic comprises ZrO₂, that is stabilized by Y₂O₃ in 6-8% mol. Other materials that have been studied in the aerospace industry as potential YSZ substitutes include the lanthanum hexaaluminates (LHA), pervoskites (like the SrZrO₃ used in the ALTP sensor and pyrochlores. From all of the above, pyrochlores are the most promising candidates since they can withstand higher temperatures than YSZ and have higher resistance to Calcium-Magnesium-Aluminosilicate (CMAS), a type of debris that is formed during volcanic activity and can penetrate and destroy TBCs. However, their thermal expansion coefficient and fracture toughness is lower than YSZ, meaning that they are subject to higher stresses and fracture. To involve them in TBC design, a double layer of Gadolinium Zirconate coating (Gd₂Zr₂O₇) on top of YSZ coating has been observed to combine advantages from both coatings. In addition, the silicide coatings family is well known for their resistance in high temperature oxidizing atmospheres. More specifically, R512E and Yb₂Si₂O₇ are well known coatings for the C103 and CMC substrates, respectively.

All of the coatings mentioned above are traditional low-k coatings. However, the dynamic heat Insulation coating concept requires the use of low-ρc coatings, i.e., porous material with low effective density and low specific heat capacity. Research in dynamic heat flux environments like the reciprocating internal combustion engines has revealed certain low-ρc coatings that improve the engine efficiency. One of these coatings is the Toyota SiRPAC coating, which is anodized aluminum coated with silica. The anodizing process creates pores, reducing ρ, thus ρc. Another coating that has been introduced and tested successfully is the RC/PC coating (aluminosilicate coatings with polysilazane/metal phosphate binders). The aluminosilicate particles that are used in the coating incorporate trapped air which results in low density and thermal conductivity.

In FIG. 3, Toyota SiRPA and RC/PC reveal a coating trend line that could be adopted in dynamic thermal environments. The arrow shows towards the increasing temperature swing direction, T_{swing}=T_{wall,max}−T_{wall,min}, since RC/PC provides better temperature swing than the Toyota SiRPA. In this trendline, two concept coatings are introduced. The present Concept 1 coating is interpolated to make the trend more visible, and the present Concept 2 coating is extrapolated to expand the trend capabilities to potentially more efficient RDE coatings are example coatings and/or materials that can be used as or in conjunction the insulating layer according to examples of the present disclosure. Consequently, present Concept 1 is an intermediate dynamic heat insulation case and present Concept 2 is expected to significantly enhance performance to the insulating layer according to the examples of the present disclosure.

First, to understand how each thermophysical property or detonation regime affects the problem, a separate analysis for coating thermal conductivity k, volumetric heat capacity, ρc, thickness, L and frequency, f (or number of waves) is carried out. The heat flux, \dot{q}″, and backside temperature, T_{N}, boundary conditions are expected to vary for different materials in actual conditions. However, in this work they are kept same for each analysis to isolate the material thermal property effects. The heat flux magnitude is equal to A=30 MW/m² during detonation phase and the offset is set to

$${\dot{q}}_{offset}^{″} = - 1 MW / {m}^{2}$$

for the reactants refill phase, following the pattern of the experimental heat flux shown in Athmanathan, V., Wang, R. B., Webb, A. M., Huber, K., Rödiger, T., Braun, J., Roy, S., Fugger, C. A., and Meyer, T. R., “MHz Rate In-Situ Direct Surface Heat-Flux Measurements in a Rotating-Detonation Engine,” AIAA SCITECH 2025 Forum, 2025, p. 2146. The heat flux signal was recorded several periods before the detonation is terminated, when operation resembled “steady” conditions for the gas. “Steady” conditions in an RDE refer to when the heat flux pattern is relatively repeatable. For example, the detonation pattern is less stable in the beginning due to cold engine transient conditions. The period cycle time is set to be a function of the fuel-oxidizer mixture, number of waves and engine diameter. For this work's default heat flux profile, H₂-air mixture is considered at equivalence ratio @=1, one dominant wave, and engine diameter d=110 mm. To calculate the detonation wave velocity, the software SDToolbox was used. These considerations set the wave frequency at f=5000 Hz (1/f=200 μs). The substrate material was SS316 with thickness L_{substrate}=2 mm.

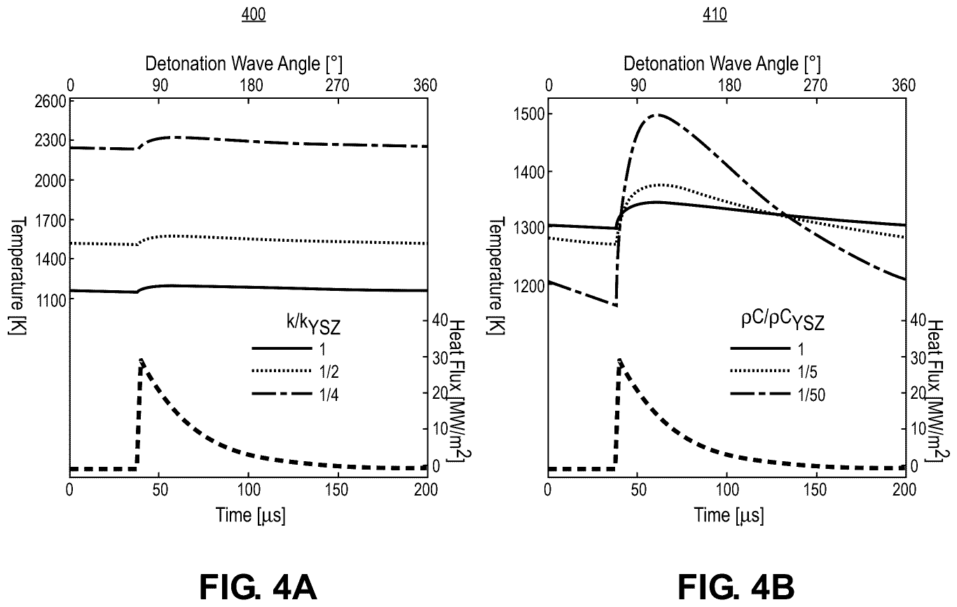

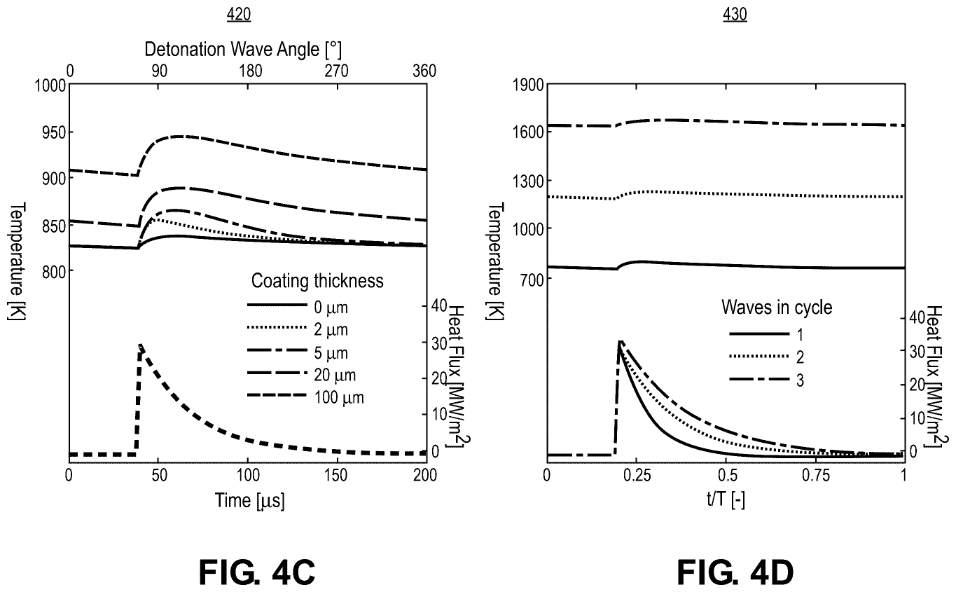

FIG. 4A shows a plot 400 of temperature versus time showing time-resolved surface temperature swing for coating thermal conductivity, k, FIG. 4B shows a plot 410 of temperature versus time showing time-resolved surface temperature swing for coating volumetric heat capacity, ρc, FIG. 4C shows a plot 420 of temperature versus time showing time-resolved surface temperature swing for coating thickness, L, and FIG. 4D shows a plot 430 of temperature versus time showing time-resolved surface temperature swing for a number of detonation waves according to examples of the present disclosure.

FIG. 4A shows the effect of coating thermal conductivity, k, on the time-resolved surface temperature for the given heat flux discussed above. Three different coatings were evaluated with L_{coating}=200 μm, ρc=ρc_{YSZ} and thermal conductivities of 1, 1/2 and 1/4 equivalent YSZ ratios. The YSZ coating is current state of the art hence it is used as reference in this work. The cycle-mean surface temperature is increased for decreasing thermal conductivity. This behavior is expected. However, the magnitudes are more pronounced since the boundary condition heat flux is constant among the cases. On the other hand, T_{swing} remains fixed for decreasing k, since the property affects steady state heat transfer.

FIG. 4B shows the effect of coating volumetric heat capacity, ρc, on the time-resolved surface temperature. The thickness was L_{coating}=200 μm and k=k_{YSZ}. Three different coatings were evaluated with volumetric heat capacities of 1, 1/5 and 1/50 relative to the volumetric heat capacity of the YSZ. The ability of the coating surface temperature to follow the gas temperature is increased for decreasing ρc/ρc_{YSZ}. The ρc/ρc_{YSZ}=1/5 case has a slight improvement over the standard YSZ coating. The ρc/ρc_{YSZ}=1/50 has a significant improvement, where the T_{swing} improved by 250 K in the detonation phase and by about 150 K at the reactants refill phase. While experimental data available in the literature remain limited for quantifying the efficiency gain, it is believed that the dynamic heat insulation effect is a strong function of the coating volumetric heat capacity.

FIG. 4C shows the effect of coating thickness on the surface temperature. A YSZ coating is used with k and ρc described in FIG. 3. The thickness ranges from the uncoated SS316 substrate (0 μm) to 100 μm. The cycle-mean and T_{swing} are increased for increasing L. The former is steadily increased, however the latter is bounded at about 20 μm. This observation is useful and introduces the critical coating thickness consideration, L_{critical}. It is hypothesized that L_{critical} is the critical thickness for which the coating capacitance, C=ρcL, becomes saturated. Any thickness above this value is anticipated to penalize performance and decrease structural integrity. The temperature oscillations, see FIG. 2D, inside the material and while moving from x=0 to x=L_{critical} gradually decay until x=L_{critical}. Any thickness addition after that point will offset the cycle-mean T_{wall}, as seen in FIG. 4C. A similar coating thickness behavior has also been observed for ICEs, with thicknesses an order of magnitude higher, as L_{critical} scales with the frequency of the problem.

FIG. 4D shows the time-resolved T_{wall} output for different number or waves and

$${\dot{q}}_{loss}^{″} - per - wave inputs .$$

The horizontal axis was non-dimensionalized to fit a single wave. While the cycle-mean wall temperature increases for increasing number of waves, the T_{swing} decreases insignificantly. The effect of wave number is anticipated to be a strong function of the material performance. This is why it is highlighted that the relationship between the number of waves and the heat flux losses. First, the number of waves is a system output which depends on multiple variables, e.g., injector geometry, fuel-oxidizer mixture, and chamber pressure. Second, to this date, the open literature is limited and omits such relation. According to a numerical study on H₂/Air mixtures, the number of waves scaled linearly with mass flux. Thus, in the present disclosure, it is assumed that the mass flux scales linearly with the heat flux. The peak heat flux and decay rate, see terms A and B in Eq. (3), respectively, were adjusted to approximately match the time-average heat flux shown above.

A greater advantage is expected when all of these properties are combined, following the trend presented in FIG. 3. A simultaneous decrease in k and ρc will reduce the heat losses further than a decrease in k or ρc alone. Furthermore, from a practical standpoint, k, ρ and c are intertwined material properties. For example, decrease in k value could be achieved by increasing porosity. However, this will decrease ρ as well, thus the volumetric heat capacity. An attempt to show combined material property effects is shown next.

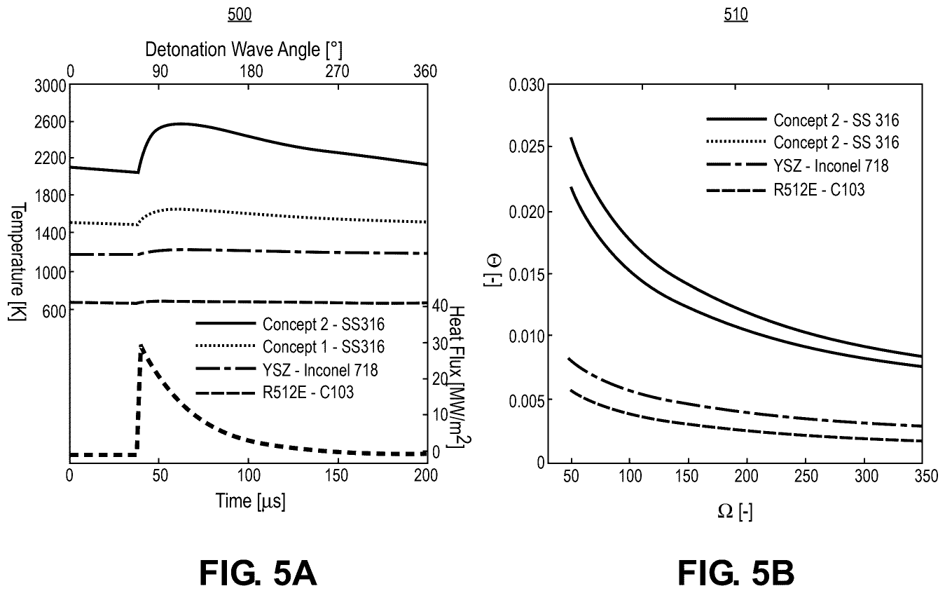

FIG. 5A shows a plot 500 of temperature versus time showing coating-substrate combinations comparison and FIG. 5B shows a plot 510 of temperature versus time showing non-dimensional representation Θ-Ω according to examples of the present disclosure.

FIG. 5A shows the surface temperature response as a function of time for four different coating-substrate cases, R512E—C103, YSZ—Inconel 718, Concept 1—SS316 and Concept 2—SS316. The first and second case are encountered in gas turbine and rocket propulsion applications respectively and the last two cases are concepts derived from the trend discussed in FIG. 3. The coating thickness, L=100 μm and the substrate thickness is 2 mm. The boundary conditions for \dot{q}″(t) and T_{N} remain unchanged. The R512E—C103 case show a constant surface temperature which is relatively lower than the other cases, increasing heat losses. The YSZ-Inconel 718 shows a negligible T_{swing} since the YSZ ρc is still high, however the surface temperature increases due to the lower k of YSZ. For the combination Concept 1-SS316, there is an observable temperature swing around 200 K, whereas the cycle-mean T_{wall} increases. Finally, the combination Concept 2—SS316 presents a temperature swing around 500 K, with the mean surface temperature around 2300 K. This hypothetical material may offer benefits in increasing materials survivability, reducing cooling requirements and enhancing pressure gain. Future material developments are required to design, manufacture and test to measure actual performance.

FIG. 5B provides information on the temperature difference T_{wall,max}−T_{wall,min} under different detonation wave frequencies and material properties. Two non-dimensional numbers are employed to group all dependent parameters and generalize the problem: the dimensionless time scale, Ω and the dimensionless temperature, Θ.

$$Ω = f R C \qquad ( 5 )$$

$$Θ = \frac{{T}_{max} - {T}_{min}}{( {\dot{q}}_{max}^{″} - {\dot{q}}_{min}^{″} ) {R}_{total}} \qquad ( 6 )$$

where R=L/k, C=Lρc and Rₜₒₜₐₗ=R_{coating}+R_{substrate}. The min and max subscripts refer to the maximum and minimum temperature and heat flux observed in the cycle, as can be seen in FIG. 5A. Ω is a non-dimensional parameter that shows that the detonation wave frequency f scales with the coating thermal time scale T=RC. Θ is a non-dimensional number that measures the temperature swing, T_{wall,max}−T_{wall,min}, for a given heat flux amplitude,

$${\dot{q}}_{max}^{″} - {\dot{q}}_{min}^{″}$$

and the total thermal resistance of a two-layer wall, Rₜₒₜₐₗ. Fundamentally, Θ can be regarded as the efficiency of the coating in a dynamic heat transfer problem.

As expected, Concept 2 is the most efficient since its temperature swing is the largest. The lower values of Θ compared to the ones in Koutsakis, G., Nellis, G., and Ghandhi, J., “Surface temperature of a multi-layer thermal barrier coated wall subject to an unsteady heat flux,” International Journal of Heat and Mass Transfer, Vol. 155, 2020, p. 119645 can be attributed to the fact that, even though 22 got two orders of magnitude larger than the one observed in reciprocating internal combustion engines, the coatings simulated in Koutsakis, G., Nellis, G., and Ghandhi, J., “Surface temperature of a multi-layer thermal barrier coated wall subject to an unsteady heat flux,” International Journal of Heat and Mass Transfer, Vol. 155, 2020, p. 119645 are similar to the ones used in the present disclosure.

This disclosure provides for dynamic heat insulation for rotating detonation engines to reduce instantaneous heat fluxes. This concept is demonstrated by depositing a surface layer or coating at the combustor chamber wall surface. The ideal coating material may have thermal time scale similar to the detonation wave frequency. As such, the coating will absorb and release thermal energy to reduce instantaneous heat flux and demote likelihood of parasitic deflagration. A one-dimensional transient heat diffusion solution used the matrix and complex analysis Laplace transform inversion technique for RDE dynamic heat flux boundary conditions. A variation in material properties and detonation regime revealed that the thermal conductivity, k and detonation wave frequency, f affect the cycle-mean surface temperature, ρc has high influence in the surface temperature swing and L can provide a maximum temperature swing until a critical thickness. Thus, dynamic heat flux environments may benefit from coatings that have low thermal conductivity, k, low volumetric heat capacity, ρc and a relatively low thickness, L, that may not exceed a critical coating thickness, L_{critical} for durability considerations.

Conceptual coating architectures derived from this work have demonstrated better thermal performance relative to state of the art configurations used in constant-pressure propulsion and power generation combustors. The nondimensional representation facilitated direct comparison of different coating-substrate configurations. The coating effectiveness scales with the product of thermal time constant and detonation wave frequency. The proposed concept indicated a direction towards potentially increased material survivability, reduced cooling requirements, and enhanced pressure gain.

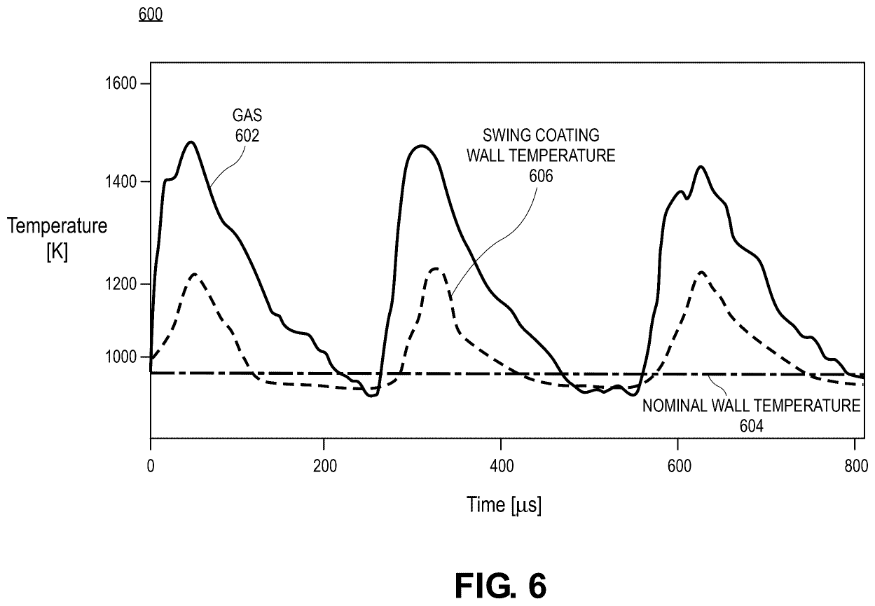

FIG. 6 shows a plot 600 of data for the time variation in gas temperature, shown by line 602, taken from Rein et al. (2017). Superimposed are the nominal wall temperatures, shown by line 604, in a rotating detonation engine together with the expected surface temperature variation with a swing or dynamic coating shown by line 606.

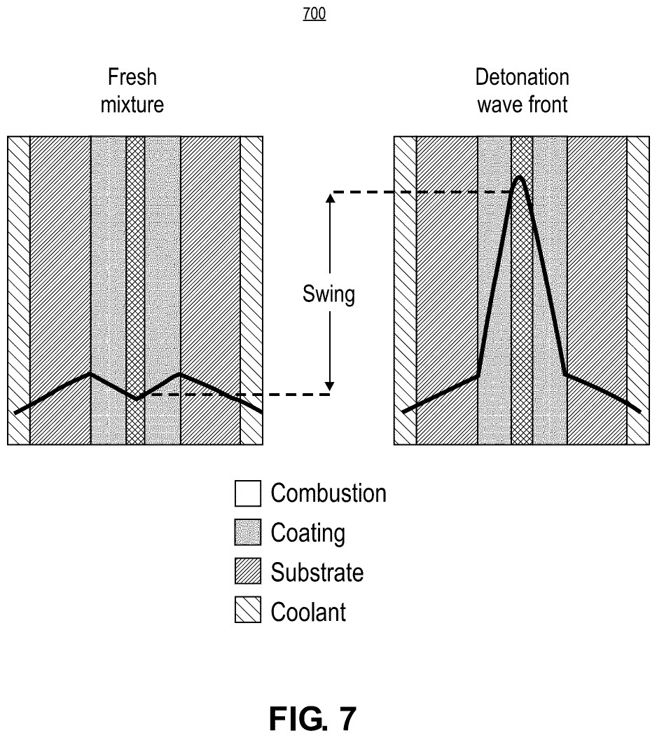

FIB. 7 shows a schematic illustration 700 of the inner and outer wall temperature distribution during the fresh mixture cooling phase and the detonation wave front phase according to examples of the present disclosure. It is hypothesized that the periodic heat flux variations associated with the individual detonation waves are too rapid for the coating to follow. In the swing or dynamic coating approach, a thin coating is considered with such properties that has sufficient time to respond to the cyclic heat fluxes and can follow the rapid gas temperature swings. Because the heat transfer is driven by the gas-wall temperature difference, these coatings reduce heat transfer to the combustion surfaces. The concept of “swing or dynamic” coatings is explained next. FIG. 6 shows the time-resolved temperature of an RDE at a quasi-steady-state thermal condition at a fixed location near the detonation wave. The gas temperature illustrated is from experimental measurements by Rein et al. (2017). Two scenarios are presented for the wall surface temperature. The first one, shown as “Nominal Wall Temperature”, is expected to be almost constant during the whole cycle time and over many cycles. Therefore, the gas-wall temperature differential is largest during the passage of the detonation wave period, and this is the main cause of heat loss by conduction into the combustion chamber. The second scenario corresponds to the wall temperature of a “swing or dynamic” coating. The envisioned “swing or dynamic” effect will not result from developing new materials but instead will arise from the strategic combination of existing materials and their thicknesses. A “swing or dynamic” coating has such a thermal-conductivity and heat capacity so that it can rapidly change its surface temperature, minimizing the instantaneous temperature difference with the hot gas. By Newton's convection law this, in turn, minimizes the instantaneous heat lost by conduction into the chamber.

$${\dot{q}}^{″} \dot{( t )} = h ( t ) [ {T}_{gas} ( t ) - {T}_{o , wall} ( t ) ]$$

where \dot{q}″(t) and h(t) are the instantaneous heat flux and heat transfer coefficient, respectively. The terms T_{gas}(t) and T_{o,wall}(t) represent the gas and surface wall temperature, respectively. The instantaneous temperature distribution of the inner and outer walls is captured during the coldest and hottest time during one cycle, as shown in time in FIG. 7, according to examples of the present disclosure that shows examples of the various arrangement of the combustion, coating, substrate, and cooling layers as described herein. The coating layer and/or substrate layer can have one or more of the properties shown in the below Table and/or one or more of the properties otherwise disclosed herein. The first is shown during the cooling phase when the fresh mixture enters the chamber; and the temperature distribution within the coating follows the temperature of the reactants. The second is depicted during the time of detonation wave front passage; the temperature distribution within the coating follows the hot combustion gas. The surface temperature range during the cycle time defines the “swing.” The aim is to minimize the instantaneous heat flux, thereby reducing the time-averaged heat flux during the cycle. This approach will trap more heat in the chamber's contents, resulting in higher gas temperatures and pressures. These conditions will yield to higher enthalpy, contributing to pressure gain and enhancing the overall efficiency of the system.

In some examples, the insulating layer(s) can be a new material or can be a strategic combination of existing material properties, such as a metal, ceramic, or a combination of a metal and a ceramic. Some examples can include stainless steel and ceramic thermal barrier coatings used in the aerospace industry, such as Yttria Stabilized Zirconia. In some examples, the insulating layer(s) can have a predetermined porosity, such that the more porous the material is, the lower the density which is anticipated to reduce the volumetric heat capacity. Therefore, this provides higher temperature swings within the cycle. Thus, this will be beneficial to reduce instantaneous heat fluxes.

Example temperature swing/dynamic insulation coating/material property bounds are as follows.

This table comprises example upper and lower material-property bounds that can be used in the present disclosure. Although some of these examples use the material in internal combustion engines, these ranges provide a design envelope for the disclosed temperature-swing thermal-insulation coating and/or the insulation layer in pressure gain combustion devices, such as the rotating detonation engines, according to examples of the present disclosure.

| Property | Lower Bound | Upper Bound |
|---|---|---|
| Thermal conductivity | 0.02 | 2.5 |
| k (W/m · K) | | |
| Volumetric heat | 200 | 2800 |
| capacity pCp | | |
| (kJ/m³ · K) | | |
| Apparent density | 0.1 | 1.0 |
| (g/cm³) | | |
| Porosity (%) | 10 | 95 |
| Insulating layer | 1 | 1000 |
| thickness (μm) | | |
| Sealing layer | 1 | 20-50 |
| thickness (μm) | | |
| Feature size: | 0.02 | 800 |
| particles/microspheres | | |
| (μm) | | |
| Pore diameter (nm) | 1 | 500 |
| Specific surface area | 100 | 1000 |
| Temperature | 1300 | 2700 |
| capability (° C.) | | |
| Mechanical strength | 70 | 3300 |
| examples (MPa) | | |

Example manufacturing approaches for temperature-swing thermal-insulation materials intended for pressure-gain combustion devices combine established coating science with emerging porous-structure engineering and are adaptable to a wide range of metallic alloys and ceramic substrates. Three example fabrication processes are described below: porous oxide formation on compatible substrates; particulate-based thermal barrier coatings (TBCs); and multilayer microsphere architectures. Each example processes targets a common objective—achieving low thermal conductivity and low volumetric heat capacity while preserving adhesion, durability, and resistance to rapid cyclic pressure and temperature transients characteristic of pressure-gain combustion systems.

A first example manufacturing process involves electrochemical or chemical oxidation processes to produce controlled porous oxide layers directly on conductive metallic substrates. In this approach, the structural component serves as an active surface within a tailored electrolyte or reactive environment, where voltage waveform, current density, temperature, and chemistry regulate pore morphology, oxide thickness, and crystallinity. Subsequent thermal treatments may stabilize the oxide structure or convert it into thermodynamically stable phases while maintaining internal porosity needed for temperature-swing behavior. Similar porous layers may also be formed on ceramic substrates through plasma oxidation, sol-gel processing, or vapor-phase deposition, enabling application across diverse material systems.

A second example manufacturing process relies on slurry-deposited particulate coatings applicable to metals, superalloys, refractory alloys, and ceramics. Hollow or low-density particles such as aluminosilicate microspheres, ceramic microballoons, perlite-derived structures, or other porous fillers may be dispersed within high-temperature precursor binders including polysilazane, metal-phosphate, oxide sol-gel, or hybrid ceramic-polymer systems. The slurry may be applied through spray coating, dip coating, spin coating, or additive deposition to form a thin insulating layer, followed by controlled curing or pyrolysis to create a porous network with reduced thermal inertia. Surface preparation methods such as grit blasting, laser texturing, chemical etching, or pre-oxidation may be employed to enhance adhesion across different substrate classes.

A third example manufacturing process emphasizes multilayer architectures in which a porous insulating layer is combined with functional bond and sealing layers compatible with both metallic and ceramic components. In these systems, hollow metallic or ceramic microspheres are assembled into a low-density matrix that is subsequently bonded to the substrate using diffusion bonding, brazing, reactive bonding, or ceramic adhesive processes depending on the substrate material. A thin sealing layer—applied by electroplating, physical or chemical vapor deposition, thermal spraying, or precursor infiltration—may reduce gas penetration into the porous structure while preserving rapid thermal response. Graded bond layers or compliant interlayers may be incorporated to manage coefficient-of-thermal-expansion mismatch and improve fatigue resistance during repeated temperature swings.

From a manufacturing standpoint, scalability depends on aligning process complexity with component geometry, substrate material, and service environment typical of pressure-gain combustion hardware. Porous oxidation routes offer strong substrate integration and precise pore control; slurry-based coatings enable compositional flexibility and scalable deposition; multilayer microsphere architectures deliver extremely low thermal inertia but require careful bonding and sealing strategies. For temperature-swing applications, manufacturing can use low density, controlled porosity, and thin insulating layers to minimize stored heat while maintaining structural integrity under high-frequency pressure oscillations. Integration into production workflows may involve pre-coating structural components, post-deposition thermal stabilization treatments, and final finishing operations to ensure dimensional tolerance and long-term durability under cyclic detonation or pressure-gain operation.

While the foregoing disclosure has been described in some detail by way of illustration and example for purposes of clarity and understanding, it will be clear to one of ordinary skill in the art from a reading of this disclosure that various changes in form and detail can be made without departing from the true scope of the disclosure and may be practiced within the scope of the appended claims. For example, all the methods, systems, and/or component parts or other aspects thereof can be used in various combinations. All patents, patent applications, websites, other publications or documents, and the like cited herein are incorporated by reference in their entirety for all purposes to the same extent as if each individual item were specifically and individually indicated to be so incorporated by reference.

What is claimed is:

1. A pressure gain combustion device comprising:
at least one component configured to be subjected to combustion gases, the component comprising:
an insulating layer, wherein the insulating layer follows a transient gas temperature profile during operation of the pressure gain combustion device.

2. The pressure gain combustion device of claim 1, further comprising a rotation detonation engine, a pulse detonation engine, a wave rotor combustor, or pulsejet engine, and wherein the insulating layer comprises a refractory alloy or a ceramic matrix composite.

3. The pressure gain combustion device of claim 1, wherein the insulating layer is a swing or dynamic coating where a thermal conductivity and a heat capacity of the insulating layer rapidly changes the surface temperature at the insulating layer while minimizing instantaneous temperature differences with combustion gases.

4. The pressure gain combustion device of claim 1, wherein the insulating layer is a swing or dynamic coating that minimizes instantaneous heat flux, thereby reducing a time-averaged heat flux during operation of the pressure gain combustion device.

5. The pressure gain combustion device of claim 1, wherein the insulating layer is a swing or dynamic coating that has a thermal conductivity between 0.02 W/m K and 2.5 W/m K, a volumetric heat capacity between 200 ρCp (kJ/m³·K) and 2800 ρCp (kJ/m³·K), a melting point between 1500° C. and 3000° C., a material thickness between 1 μm and 1000 μm.

6. The pressure gain combustion device of claim 5, wherein the swing or dynamic coating that has an apparent density between 0.1 g/cm³ and 1.0 g/cm³, a porosity percentage between 10% and 95%, a sealing layer thickness between 1 μm and 20-50 μm, a feature size between 0.02 μm and 800 μm, a pore diameter between 1 nm and 500 nm, a specific surface area between 100 and 1000, a temperature capability between 1300° C. and 2700° C., and a mechanical strength between 70 MPa and 3300 MPa.

7. The pressure gain combustion device of claim 6, wherein the feature size comprises a diameter of a particle or a microsphere.

8. A method of forming a coating for use on a component of a pressure gain device comprising:
providing a surface that is subjected to combustion gases, the surface comprises an insulating layer, wherein the insulating layer follows a transient gas temperature profile during operation of the pressure gain combustion device.

9. The method of claim 8, wherein the pressure combustion device comprises a rotation detonation engine, a pulse detonation engine, a wave rotor combustor, or pulsejet engine.

10. The method of claim 8, wherein the insulating layer is a swing or dynamic coating where a thermal conductivity and a heat capacity of the insulating layer rapidly changes a surface temperature at the insulating layer while minimizing instantaneous temperature differences with combustion gases.

11. The method of claim 8, wherein the insulating layer is a swing or dynamic coating that minimizes instantaneous heat flux, thereby reducing a time-averaged heat flux during operation of the pressure gain combustion device.

12. The method of claim 8, wherein the insulating layer is a swing or dynamic coating that has a thermal conductivity between 0.02 W/m K and 2.5 W/m K, a volumetric heat capacity between 200 ρCp (kJ/m³·K) and 2800 ρCp (kJ/m³·K), a melting point between 1500° C. and 3000° C., and a material thickness between 1 μm and 1000 μm.

13. The method of claim 12, wherein the swing or dynamic coating that has an apparent density between 0.1 g/cm³ and 1.0 g/cm³, a porosity percentage between 10% and 95%, a sealing layer thickness between 1 μm and 20-50 μm, a feature size between 0.02 μm and 800 μm, a pore diameter between 1 nm and 500 nm, a specific surface area between 100 and 1000, a temperature capability between 1300° C. and 2700° C., and a mechanical strength between 70 MPa and 3300 MPa.

14. The method of claim 13, wherein the feature size comprises a diameter of a particle or a microsphere.

15. A detonation engine comprising:
at least one component configured to be subjected to combustion gases, the component comprising:
a substrate comprising a surface; and
a coating applied to the surface, the coating comprises an insulating layer, wherein the insulating layer follows a transient gas temperature profile during operation of the pressure gain combustion device.

16. The detonation engine of claim 15, wherein the insulating layer is a swing or dynamic coating where a thermal conductivity and a heat capacity of the insulating layer rapidly changes the surface temperature at the insulating layer while minimizing instantaneous temperature differences with combustion gases.

17. The detonation engine of claim 15, wherein the insulating layer is a swing or dynamic coating that minimizes instantaneous heat flux, thereby reducing a time-averaged heat flux during operation of the pressure gain combustion device.

18. The detonation engine of claim 15, wherein the insulating layer is a swing or dynamic coating that has a thermal conductivity between 0.02 W/m K and 2.5 W/m K, a volumetric heat capacity between 200 ρCp (kJ/m³·K) and 2800 ρCp (kJ/m³·K), a melting point between 1500° C. and 3000° C., and a material thickness between 1 μm and 1000 μm.

19. The detonation engine of claim 18, wherein the swing or dynamic coating that has an apparent density between 0.1 g/cm³ and 1.0 g/cm³, a porosity percentage between 10% and 95%, a sealing layer thickness between 1 μm and 20-50 μm, a feature size between 0.02 μm and 800 μm, a pore diameter between 1 nm and 500 nm, a specific surface area between 100 and 1000, a temperature capability between 1300° C. and 2700° C., and a mechanical strength between 70 MPa and 3300 MPa.

20. The detonation engine of claim 19, wherein the insulating layer comprises a refractory alloy or a ceramic matrix composite.
